(19) United States
(12) Patent Application Publication
(10) Pub. No.: US 2023/0182343 A1
(43) Pub. Date: Jun. 15, 2023

(54) PROCESSING METHOD FOR WASTE ORIENTED STRAND BOARD, WASTE ORIENTED WOOD CHIPS, AND ORIENTED STRAND BOARD AND PREPARATION METHOD THEREOF

(71) Applicant: Southwest Forestry University, Yunnan Province (CN)

(72) Inventors: HUI WAN, Yunnan Province (CN); AN MAO, Yunnan Province (CN); XIAOJIAN ZHOU, Yunnan Province (CN); HONG LEI, Yunnan Province (CN); GUANBEN DU, Yunnan Province (CN)

(21) Appl. No.: 17/847,405

(22) Filed: Jun. 23, 2022

(30) Foreign Application Priority Data
Dec. 13, 2021 (CN) 202111513512.4

(51) Int. Cl. B27L 11/02; B27N 3/00; B27N 3/02

(52) U.S. Cl. CPC B27L 11/02; B27N 3/007; B27N 3/02

(57) ABSTRACT

The present disclosure relates to the technical field of resource recycling and provides a processing method for a waste oriented strand board and waste oriented wood chips, and an oriented strand board preparation method thereof. The processing method for a waste oriented strand board provided in the present disclosure includes the following steps: softening a waste oriented strand board to obtain a softened waste oriented strand board; and flaking the softened waste oriented strand board pieces using a disc flaker to obtain waste oriented wood chips. According to the present disclosure, the waste oriented strand board is softened first to be chipped readily. It is specified in the present disclosure that the disc flaker is used such that relatively intact wood chips can be obtained.

### CROSS REFERENCE TO RELATED APPLICATION

This patent application claims the benefit and priority of Chinese Patent Application No. 202111513512.4, filed on Dec. 13, 2021, the disclosure of which is incorporated by reference herein in its entirety as part of the present application.

### TECHNICAL FIELD

The present disclosure relates to the technical field of resource recycling, and in particular, to a processing method for a waste oriented strand board, waste oriented wood chips, and an oriented strand board and a preparation method thereof.

### BACKGROUND ART

A particle board is a wood composite panel made by cutting a raw material such as wood into wood chips having a certain size, drying the wood chips, mixing the wood chips with a resin, with or without a curing agent and a water-proofing agent, and hot pressing the mixed material together at a certain temperature and pressure. An oriented strand board is a novel particleboard made from resonated wood flakes or strands that are normally arranged longitudinally and transversely in three layers according to their fiber directions and hot pressed together. Such an oriented strand board has similar characteristics to a plywood and thus is often used to substitute the plywood. The oriented strand board has significant advantages such as making full use of low quality, small-dimension, and fast growing wood/tree, with an improved wood utilization rate.

An existing oriented strand board is usually made from wood strands cut from wood logs and may be costly. Besides, waste oriented strand boards may not be effectively recycled at present, which will go against the comprehensive utilization of wood resources.

### SUMMARY

The objective of the present disclosure is to provide to a processing method for a waste oriented strand board, waste oriented wood chips, and an oriented strand board and a preparation method thereof. The method provided in the present disclosure is used to process a waste oriented strand board such that relatively complete waste oriented wood chips can be obtained. The obtained waste oriented wood chips are recycled to produce a new oriented strand board. Accordingly, a new solution is provided for full utilization of wood resources, and thus the production cost of the oriented strand board will be reduced.

To achieve the above objective, the present disclosure provides the following technical solutions.

The present disclosure provides a processing method for a waste oriented strand board, including the following steps:

softening a waste oriented strand board to obtain a softened waste oriented strand board; and

flaking the softened waste oriented strand board using a disc flaker to obtain waste oriented wood chips/strands.

Preferably, the softening includes impregnating the waste oriented strand board in water.

Preferably, the impregnating is normal pressure impregnation or vacuum pressure impregnation.

Preferably, upon flaking, the disc flaker operates at a revolving speed of 15 to 35 rpm with a knife sharpness angle of 17° to 32°, a back micro-bevel angle of 5° to 35°, a counter knife angle of 38° to 78°, a knife clearance angle of 1° to 10°, and a knife projection of 0.2 to 1.0 mm.

Preferably, the processing method further includes drying the wood chips to obtain the waste oriented wood chips after flaking, where the waste oriented wood chips have a moisture content of 2-14wt %.

The present disclosure provides waste oriented wood chips obtained by using the preparation method described in the above technical solution.

The present disclosure further provides an oriented strand board including a top surface layer, a bottom surface layer, and a core layer disposed between the top surface layer and the bottom surface layer.

Raw materials for the top surface layer and the bottom surface layer include fresh wood chips and an isocyanate resin.

Raw materials for the core layer include waste oriented wood chips, fresh wood chips, and an isocyanate resin. The waste oriented wood chips are the waste oriented wood chips obtained by using the preparation method described in the above technical solution or the waste oriented wood chips obtained according to the above technical solution. The waste oriented wood chips accounts for no more than 75% by mass of the core layer.

Preferably, the raw materials for the top surface layer and the bottom surface layer further include waste oriented wood chips.

Preferably, an included angle between laid wood chips of the top surface layer, the core layer and the bottom surface layer is 0° to 90°.

The present disclosure provides a preparation method of the oriented strand board according to the above technical solution, including the following steps:

mixing the raw materials for the top surface layer, the raw materials for the bottom surface layer and the raw materials for the core layer to obtain a top surface layer mixture, a bottom surface layer mixture, and a core layer mixture, respectively;

laying the top surface layer mixture, the bottom surface layer mixture, and the core layer mixture orderly from bottom to top to obtain a mat ; and

subjecting the mat to hot pressing to obtain the oriented strand board.

The present disclosure provides a processing method for a waste oriented strand board, including the following steps: softening a waste oriented strand board to obtain a softened waste oriented strand board; and flaking the softened waste oriented strand board using a disc flaker to obtain waste oriented wood chips. According to the present disclosure, the waste oriented strand board is softened first to be flaked readily. It is specified in the present disclosure that the disc flaker is used such that relatively complete wood chips can be obtained. Thus, the utilization rate of the waste oriented wood chips can be improved.

The present disclosure further provides an oriented strand board. Waste oriented wood chips and fresh wood chips are mixed to prepare an oriented strand board in the present disclosure. In this manner, the utilization rate of the waste oriented wood chips can be improved while the quality of the oriented strand board is guaranteed. The production cost will be reduced. Good economic and environmental protection benefits will be yielded.

### BRIEF DESCRIPTION OF THE DRAWINGS

FIG. 1 shows an image of real waste oriented wood chips prepared in Example 1 of the present disclosure.

### DETAILED DESCRIPTION OF THE EMBODIMENTS

The present disclosure provides a processing method for a waste oriented strand board, including the following steps:

soften a waste oriented strand board to obtain a softened waste oriented strand board; and

flake the softened waste oriented strand board using a disc flaker to obtain waste oriented wood chips.

According to the present disclosure, the waste oriented strand board is softened to obtain a softened waste oriented strand board. In the present disclosure, the processing method further includes a pre-processing of the waste oriented strand board before the softening. The pre-processing includes cutting the oriented strand board into waste oriented strand board pieces. In the present disclosure, the waste oriented strand board pieces have a size of preferably 13-62.2 cm×13-94 cm×1-5 cm.

In the present disclosure, the softening preferably includes impregnating the waste oriented strand board in water. The present disclosure has no particular requirement on the amount of the water added as long as the oriented strand board can be completely impregnated in the water. In the present disclosure, the water may preferably be tap water. In the present disclosure, the impregnating is preferably normal pressure impregnation or vacuum pressure impregnation. In the present disclosure, the impregnation preferably lasts for less than 72 h, more preferably 24 h.

In the present disclosure, the vacuum pressure impregnation is preferably conducted by a process including: placing the waste oriented strand board pieces and water in a vacuum pressure vessel, vacuumizing, and then applying a pressure. In the present disclosure, the vacuumizing is conducted to achieve a vacuum degree of preferably −0.033 to −94.8 kPa, more preferably −94.8 kPa, preferably for less than 100 min, more preferably 15 to 50 min. In the present disclosure, a method of applying a pressure after the vacuumizing preferably includes injecting compressed air into the vacuum pressure vessel. In the present disclosure, the pressure applied is preferably less than 10 MPa, more preferably 0.5 to 5 MPa. The pressure is maintained for preferably less than 60 min, more preferably 20 to 40 min. It is preferred in the present disclosure that still standing for 60 min is allowed after applying the pressure such that the water can fully infiltrate into the waste oriented strand board pieces. Vacuum impregnation is used in the present disclosure such that the softening efficiency can be improved while the softening effect is guaranteed.

In the present disclosure, after the softened waste oriented strand board pieces is obtained, the softened waste oriented strand board pieces is chipped/flaked by using the disc flaker to obtain waste oriented wood chips. In the present disclosure, upon flaking, the disc flaker is operated at a revolving speed of preferably 15 to 35 rpm, more preferably 27 to 30 r/min, with a knife sharpness angle of preferably 17° to 32°, more preferably 22° to 30°, a back micro-bevel angle of preferably 5° to 35°, more preferably 10° to 20°, a counter knife angle of preferably 38° to 78°, more preferably 58° to 68°, a knife clearance angle of preferably 1° to 10°, more preferably 5° to 8°, and a knife projection of preferably 0.2 to 1.0 mm, more preferably 0.6 to 0.8 mm. In the present disclosure, flaking parameters are reasonably set such that knife wear during flaking can be avoided.

In the present disclosure, the processing method preferably further includes drying the obtained wood chips after the flaking to obtain waste oriented wood chips. In the present disclosure, a temperature for the drying is preferably below 160° C., more preferably 90° C. to 110° C. In the present disclosure, the waste oriented wood chips have a moisture content of preferably 2-14wt %, more preferably 5-6wt %.

In the present disclosure, the processing method preferably further includes sieving the obtained dry wood chips after the drying to obtain waste oriented wood chips. In the present disclosure, the sieving is performed on an 8-mesh sieve. In the present disclosure, the sieving is performed such that dust in the wood chips is removed.

The present disclosure further provides waste oriented wood chips obtained by using the preparation method described in the above technical solution. In the present disclosure, the waste oriented wood chips have a thickness of preferably 0.2 to 1.0 mm, more preferably 0.6 to 0.8 mm, and have a size of preferably 1 to 16 mesh, more preferably 8 to 12 mesh.

The present disclosure provides an oriented strand board including a top surface layer, a bottom surface layer, and a core layer disposed between the top surface layer and the bottom surface layer.

Raw materials for the top surface layer and the bottom surface layer include fresh wood chips, wax and an isocyanate resin.

Raw materials for the core layer include waste oriented wood chips, fresh wood chips, wax and an isocyanate resin. The waste oriented wood chips are the waste oriented wood chips obtained by using the preparation method described in the above technical solution or the waste oriented wood chips obtained according to the above technical solution. The waste oriented wood chips accounts for no more than 75% by mass of the core layer.

The oriented strand board provided in the present disclosure includes a top surface layer, a bottom surface layer, and a core layer disposed between the top surface layer and the bottom surface layer. In the present disclosure, a thickness ratio of the top surface layer to the core layer and the bottom surface layer is preferably 17-30:40-56:17-30, more preferably 25:50:25.

The oriented strand board provided in the present disclosure includes a top surface layer. In the present disclosure, raw materials for the top surface layer include fresh wood chips, wax and an isocyanate resin. In the present disclosure, the fresh wood chips are preferably selected from poplar, pine, birch, fir, maple or eucalyptus wood chips, more preferably poplar wood chips. The fresh wood chips have a length of preferably 5 to 23 cm, more preferably 15 to 20 cm. In the present disclosure, the isocyanate resin is preferably Methylene diphenyl diisocyanate (MDI). In the present disclosure, the isocyanate preferably accounts for 1-8%, more preferably 2.4-6% by mass of the fresh wood chips in the upper surface layer. In the present disclosure, the raw materials for the top surface layer preferably further include paraffin, more preferably emulsified paraffin wax. In the present disclosure, the emulsified paraffin wax has a solid content of preferably 58wt %. In the present disclosure, the paraffin wax preferably accounts for 0.5-2%, more preferably 1.3% by mass of the fresh wood chips in the top surface layer. In the present disclosure, the paraffin wax can reduce the water absorption expansion rate of wood on the one hand, and can serve as a lubricant to improve the mixing uniformity of wood chips and reduce the thermal compressive stress on the other hand.

In the present disclosure, the raw materials for the top surface layer preferably further include the waste oriented wood chips according to the above technical solution. In the present disclosure, the waste oriented wood chips in the top surface layer preferably accounts for no more than 75%, more preferably 5-50% by mass of the entire top surface layer. In the present disclosure, when the raw materials for the top surface layer further include the waste oriented wood chips, the isocyanate resin preferably accounts for 1-8%, more preferably 2.4-6% by mass of the total waste oriented wood chips and fresh wood chips in the top surface layer. When the raw materials for the top surface layer further include paraffin, the paraffin preferably accounts for 0.5-2%, more preferably 1.3% by mass of the total waste oriented wood chips and fresh wood chips in the top surface layer.

In the present disclosure, the bottom surface layer is preferably the same as the top surface layer in composition, which will not be described redundantly here.

The oriented strand board provided in the present disclosure includes a core layer disposed between the top surface layer and the bottom surface layer. In the present disclosure, the raw materials for the core layer include waste oriented wood chips, fresh wood chips, and an isocyanate resin. In the present disclosure, the waste oriented wood chips in the core layer preferably accounts for no more than 75%, preferably 5-50% by mass of the entire core layer. In the present disclosure, the fresh wood chips are preferably selected from poplar, pine, birch, fir, maple or eucalyptus wood chips, more preferably poplar wood chips. The fresh wood chips have a length of preferably 5 to 23 cm, more preferably 15 to 20 cm. In the present disclosure, the isocyanate resin is preferably MDI. In the present disclosure, the isocyanate resin preferably accounts for 1-8%, more preferably 2.4-6% by mass of the total waste oriented wood chips and fresh wood chips in the core layer. In the present disclosure, the raw materials for the core layer preferably further include paraffin wax, more preferably emulsified paraffin wax. In the present disclosure, the emulsified paraffin wax has a solid content of preferably 58wt %. In the present disclosure, the paraffin wax preferably accounts for 0.5-2%, more preferably 1.3% by mass of the total waste oriented wood chips and fresh wood chips in the core layer.

In the present disclosure, an included angle between laid wood chips of the top surface layer, the core layer and the bottom surface layer is preferably 0° to 90°, more preferably 90°.

The present disclosure further provides a preparation method of the oriented strand board according to the above technical solution, including the following steps:

mix the raw materials for the top surface layer, the raw materials for the bottom surface layer and the raw materials for the core layer to obtain a top surface layer mixture, a bottom surface layer mixture, and a core layer mixture, respectively;

lay the top surface layer mixture, the bottom surface layer mixture, and the core layer mixture orderly from bottom to top to obtain a mat ; and

subject the mat to hot pressing to obtain the oriented strand board.

In the present disclosure, the raw materials for the top surface layer, the raw materials for the bottom surface layer and the raw materials for the core layer are mixed to obtain a top surface layer mixture, a bottom surface layer mixture, and a core layer mixture, respectively. In the present disclosure, a method of mixing preferably includes: atomize and spray the isocyanate resin on the fresh wood chips, or on the mixture of the waste oriented wood chips and the fresh wood chips. In the present disclosure, the isocyanate resin is atomized preferably under a pressure of 0 to 1 MPa, more preferably 0.4 to 0.6 MPa. In the present disclosure, the mixing time preferably lasts for 0 to 10 min, more preferably 2 to 5 min. In the present disclosure, the mixing is preferably performed in a glue blender which has a depth of preferably 1.2 m and a diameter of preferably 1.5 m. In the present disclosure, the glue blender operates at a revolving speed of preferably 10 to 30 rpm, more preferably 23 rpm.

In the present disclosure, when the raw materials for the top surface layer, the bottom surface layer and the core layer further include paraffin wax, the method of mixing preferably includes: firstly atomize and spray the paraffin wax on the fresh wood chips or the mixture of the waste oriented wood chips and the fresh wood chips to obtain paraffin wax coated wood chips; and then atomize and spray the isocyanate resin on the paraffin wax coated wood chips. In the present disclosure, the paraffin wax is atomized preferably under a pressure of 0 to 1 MPa, more preferably 0.4 to 0.6 MPa. In the present disclosure, the isocyanate resin is atomized preferably under a pressure of 0 to 1 MPa, more preferably 0.4 to 0.6 MPa. In the present disclosure, the mixing time preferably lasts for 2 to 10 min, more preferably 4 to 6 min.

In the present disclosure, after the top surface layer mixture, the bottom surface layer mixture and the core layer mixture are obtained, the top surface layer mixture, the bottom surface layer mixture and the core layer mixture are laid orderly from bottom to top to obtain a mat . In the present disclosure, the laying is preferably performed by using an oriented laying machine. An included angle between laid wood chips of the top surface layer, the core layer and the bottom surface layer is preferably 0° to 90°, more preferably 90°. In the present disclosure, in the mat , the wood chips of the top surface layer and the bottom surface layer independently have a moisture content of preferably 7-8wt %, and the wood chips of the core layer has a moisture content of preferably 5wt %.

In the present disclosure, after a mat is obtained, the mat is subjected to hot pressing to obtain an oriented strand board. In the present disclosure, the hot pressing is performed at a temperature of preferably 140° C. to 260° C., more preferably 160° C. to 220° C., for preferably 100 to 300 seconds, more preferably 150 to 200 seconds, under a pressure of preferably 1 to 10 MPa, more preferably 5 to 8 MPa.

It is preferred in the present disclosure that air is vented after the hot pressing to obtain the oriented strand board. In the present disclosure, the air is vented preferably for 5 to 60 seconds, more preferably 20 to 40 seconds.

It is preferred in the present disclosure that maintenance of the obtained board is performed after the hot pressing and venting air to obtain the qualified oriented strand board. In the present disclosure, as required, the maintenance is performed with a relative humidity of preferably 65% at a temperature of preferably 20° C., preferably for 3 weeks.

The technical solutions in the present disclosure will be described clearly and completely below in conjunction with examples of the present disclosure. Apparently, the described examples are merely some rather than all of the examples of the present disclosure. All other examples derived from the examples of the present disclosure by a person of ordinary skill in the art without creative efforts shall fall within the protection scope of the present disclosure.

A glue blender used in the following examples and comparative examples has a depth of 1.2 m and a diameter of 1.5 m and is operated at a revolving speed of 23 r/min.

### EXAMPLE 1

A waste oriented strand board is sawed into 13 cm×13 cm×1.1 cm square pieces, thereby obtaining waste oriented strand board pieces. The waste oriented strand board pieces are put into a vacuum pressure vessel. The vacuum pressure vessel is filled with tap water and vacuumized to create a pressure of −94.563 kPa for 15 min. After vacuumizing, a pressure of 0.5 MPa is applied into the vessel for 20 min. Still standing of 60 min is allowed for softening to obtain softened waste oriented strand board.

The softened waste oriented strand board is chipped by using a disc flaker under the following conditions: a revolving speed of the disc flaker: 27 rpm; a knife sharpness angle: 22°; a back micro-bevel angle: 10°; a counter knife angle: 58°; a knife clearance angle: 5°; and a knife projection: 0.6 mm.

The obtained wood chips are dried to a moisture content of 5%, and then 10 kg of dry wood chips are sieved through an 8-mesh sieve having a diameter of 1.5 m to remove dust in 5 min, thereby obtaining waste oriented wood chips.

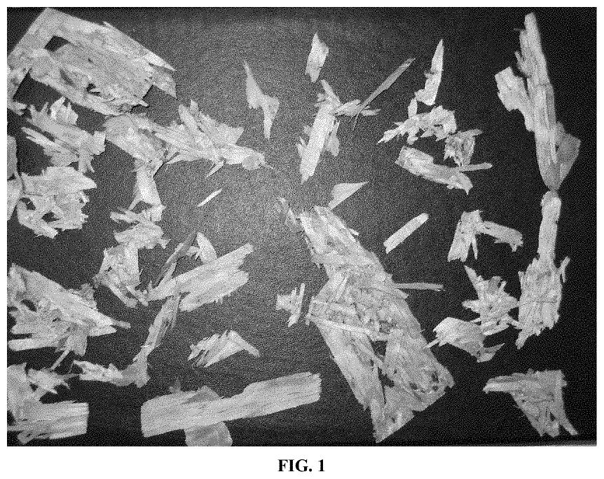

The waste oriented wood chips prepared in this example, as shown in FIG. 1, have a thickness of 0.6 mm and a size of greater than 8 mesh.

### EXAMPLE 2

A recycling or recovery rate of the waste oriented wood chips is 25%.

1000 g of 15 cm long poplar wood chips are placed into the glue blender, and emulsified paraffin having a solid content of 58wt % is atomized and sprayed into the glue blender under a pressure of 0.4 MPa. The poplar wood chips and the emulsified paraffin are mixed for 2 min to obtain paraffin wax coated wood chips. The paraffin wax accounts for 1.3% by mass of the poplar wood chips. MDI resin is then atomized and sprayed into the glue blender under a pressure of 0.4 MPa and mixed with the above mixture at 23 rpm for 2 min to obtain a mixture for the top and bottom surface layers. The MDI accounts for 2.4% by mass of the poplar wood chips.

500 g of the waste oriented wood chips prepared in Example 1 and 500 g of 15 cm long fresh poplar wood chips are placed into the glue blender and mixed at a revolving speed of 23 rpm to obtain mixed wood chips. Emulsified paraffin wax having a solid content of 58wt % is atomized and sprayed into the glue blender under a pressure of 0.4 MPa and mixed with the mixed wood chips at a revolving speed of 23 rpm for 2 min to obtain paraffin wax coated wood chips. The paraffin wax accounts for 1.3% by mass of the total mixed wood chips. MDI resin is then atomized and sprayed into the glue blender under a pressure of 0.4 1MPa and mixed with the above mixture at a revolving speed of 23 rpm for 2 min to obtain a core layer mixture. The MDI resin accounts for 2.4% by mass of the total mixed wood chips.

The mixture for the top and bottom surface layers is divided into two parts having the same mass, which are used as a bottom surface layer mixture and an bottom surface layer mixture.

The bottom surface layer mixture, the core layer mixture and the top surface layer mixture are orderly laid from bottom to top by using an oriented laying machine to obtain a mat . The angle between laid wood chips of the core layer and the top surface layer or the bottom surface layer is 90°. In the mat , the wood chips of the top surface layer and the bottom surface layer have a moisture content of 7-8wt %, and the wood chips of the core layer has a moisture content of 5wt %.

The mat is subjected to hot pressing for 150 seconds under the conditions of 220° C. and 5MPa, and air is vented for 20 seconds. The obtained board is maintained for 3 weeks in an environment with a relative humidity of 65% at 20° C. to obtain the oriented strand board.

### EXAMPLE 3

A recycling or recovery rate of the waste oriented wood chips is 50%.

500 g of the waste oriented wood chips prepared in Example 1 and 500 g of 15 cm long fresh poplar wood chips are placed into the glue blender and mixed at a revolving speed of 23 rpm to obtain mixed wood chips. Emulsified paraffin wax having a solid content of 58wt % is atomized and sprayed into the glue blender under a pressure of 0.4 1MPa and mixed with the mixed wood chips at a revolving speed of 23 rpm for 2 min to obtain paraffin wax coated wood chips. The paraffin wax accounts for 1.3% by mass of the total mixed wood chips. MDI resin is then atomized and sprayed into the glue blender under a pressure of 0.4 1MPa and mixed with the above mixture at a revolving speed of 23 rpm for 2 min to obtain a mixture for the top and bottom surface layers. The MDI accounts for 2.4% by mass of the total mixed wood chips.

500 g of the waste oriented wood chips prepared in Example 1 and 500 g of 15 cm long fresh poplar wood chips are placed into the glue blender and mixed to obtain mixed wood chips. Emulsified paraffin wax having a solid content of 58wt % is atomized and sprayed into the glue blender under a pressure of 0.4 1MPa and mixed with the mixed wood chips at a revolving speed of 23 rpm for 2 min to obtain paraffin wax coated wood chips. The paraffin wax accounts for 1.3% by mass of the total mixed wood chips. MDI resin is then atomized and sprayed into the glue blender under a pressure of 0.4 MPa and mixed with the above mixture at a revolving speed of 23 rpm for 2 min to obtain a core layer mixture. The MDI resin accounts for 2.4% by mass of the total mixed wood chips.

The mixture for the top and bottom surface layers is divided into two parts having the same mass, which are used as a bottom surface layer mixture and atop surface layer mixture.

The bottom surface layer mixture, the core layer mixture and the top surface layer mixture are orderly laid from bottom to top by using an oriented laying machine to obtain a mat . An included angle between laid wood chips of the core layer and the top surface layer or the bottom surface layer is 90°. In the mat , the wood chips of the top surface layer and the bottom surface layer have a moisture content of 7-8wt %, and the wood chips of the core layer has a moisture content of 5wt %.

The mat is subjected to hot pressing under the conditions of 220° C. and 5MPa for 150 seconds, and air is vented for 20 seconds. The obtained board is maintained for 3 weeks in an environment with a relative humidity of 65% at 20° C. to obtain the oriented strand board.

### COMPARATIVE EXAMPLE 1

This example is basically the same as Example 2 except that the core layer mixture has no waste oriented wood chips.

### COMPARATIVE EXAMPLE 2

This example is basically the same as Example 2 except that the core layer mixture includes 1000 g of the waste oriented wood chips and 0 g of poplar wood chips.

### COMPARATIVE EXAMPLE 3

This example is basically the same as Example 2 except that the MDI is replaced by powder phenolic resin.

Test Example

The oriented strand boards prepared in Examples 2 and 3 and Comparative Examples 1 to 3 have a size of 11 mm×600 mm×600 mm (thickness×length×width).

The properties of the oriented strand boards prepared in Examples 2 and 3 and Comparative Examples 1 to 3 are shown in Table 1.

TABLE 1
Properties of Oriented Strand Boards Prepared in Examples 2 and 3 and Comparative Examples 1 to 3

| | | | | | | LYT15 80-2010 |
|---|---|---|---|---|---|---|
| | | | | | | Standard |
| | | | | | | (OSB/3 Type |
| | | | | | | (Thickness |
| | | | Comparative | Comparative | Comparative | between 10 |
| | Example 2 | Example 3 | Example 1 | Example 2 | Example 3 | and 18 mm)) |
| Proportion of | 25 | 50 | 0 | 50 | 25 | / |
| waste wood | | | | | | |
| chips, % | | | | | | |
| Density, kg/m³ | 682(5.1)^{A} | 670(6.2)^{A} | 677(6.1)^{A} | 667(7.2)^{A} | 656.8 | / |
| Internal bond | 0.492(20.7)^{B} | 0.476(18.2)^{B} | 0.645(17.2)^{A} | 0.455(13.4)^{B} | 0.10 | 0.32 |
| strength, MPa | | | | | | |
| Flexural | 51.5(8.6)^{A} | 28.5(19.0)^{B} | 45.8(5.9)^{A} | 48.4(9.8)^{A} | No | 20 |
| strength | | | | | | |
| (parallel), MPa | | | | | | |
| Flexural | 20.9(17.2)^{B} | 16.8(16.2)^{B} | 27.8(16.9)^{A} | 8.4(8.2)^{C} | No | 10 |
| strength | | | | | | |
| (vertical), MPa | | | | | | |
| Flexural | 4.4(6.7)^{A} | 4.7(4.9)^{B} | 7.5(5.8)^{A} | 7.9(3.5)^{A} | No | 3.5 |
| elasticity | | | | | | |
| modulus | | | | | | |
| (parallel), GPa | | | | | | |
| Flexural | 1.9(20.3)^{B} | 2.0(14.5)^{B} | 2.5(16.9)^{A} | 0.9(11.7)^{C} | No | 1.4 |
| elasticity | | | | | | |
| modulus | | | | | | |
| (vertical), GPa | | | | | | |
| 24 h Water | 9.44(17.4)^{A} | 8.16(9.7)^{B} | 9.58(11.6)^{A} | 8.49(6.7)^{A} | 27.2 | 15 |
| absorption | | | | | | |
| thickness | | | | | | |
| swelling | | | | | | |
| rate, % | | | | | | |
| Water | 19.0(16.6)^{A} | 16.8(19.2)^{A} | 18.9(14.4)^{A} | 18.1(17.0)^{A} | 35 | Not required |
| absorption | | | | | | |
| rate, % | | | | | | |

In Table 1, the numeral values in brackets are sample coefficients of variation. Average values with the same letters (A or B) in the same row have no significant difference statistically according to Duncan multiple comparisons. Since the internal bond strength of the oriented strand board of Comparative Example 3 is greatly below the standard, other properties of the oriented strand board are not tested.

As can be seen from Table 1, under the conditions of the same density and the same production process, when the proportion of the waste oriented wood chips is 25%, the waste oriented wood chips are added to the core layer, and the isocyanate resin is used instead of phenolic resin such that an oriented strand board meeting the property indexes as required by LYT1580-2010 standard for OSB/3 type can be obtained. When the proportion of the waste oriented wood chips is 25%, the waste oriented wood chips are added to the core layer, and the isocyanate resin is used such that an oriented strand board meeting the property indexes as required by LYT1580-2010 standard for OSB/3 type can be obtained. When the proportion of the waste oriented wood chips is 50%, the waste oriented wood chips are fully mixed with the fresh poplar wood chips and used in both the surface layers and the core layer of an oriented strand board, and all the property indexes of the resulting oriented strand board made with the isocyanate resin meet the property indexes as required by LYT1580-2010 standard for OSB/3 type. The performance requirements of the oriented strand board prepared according to the present disclosure can be met even after the waste oriented wood chips are added. The prepared oriented strand board has basically equal properties with Comparative Example 1. Thus, a new solution is provided for full utilization of wood resources.

The foregoing are merely descriptions of preferred embodiments of the present disclosure. It should be noted that several improvements and modifications can be made by a person of ordinary skill in the art without departing from the principle of the present disclosure, and these improvements and modifications shall also be deemed as falling within the protection scope of the present disclosure.

What is claimed is:

1. A processing method for a waste oriented strand board, comprising the following steps:
softening a waste oriented strand board to obtain a softened waste oriented strand board; and
flaking the softened waste oriented strand board using a disc flaker to obtain waste oriented wood chips.

2. The processing method according to claim 1, wherein the softening comprises impregnating the waste oriented strand board in water.

3. The processing method according to claim 2, wherein the impregnating is normal pressure impregnation or vacuum pressure impregnation.

4. The processing method according to claim 1, wherein upon flaking, the disc flaker is operated at a revolving speed of 15 to 35 rpm with a knife sharpness angle of 17° to 32°, a back micro-bevel angle of 5° to 35°, a counter knife angle of 38° to 78°, a knife clearance angle of 1° to 10°, and a knife projection of 0.2 to 1.0 mm.

5. The processing method according to claim 1, further comprising drying the wood chips to obtain the waste oriented wood chips after the flaking , wherein the waste oriented wood chips each have a moisture content of 2-14wt %.

6. Waste oriented wood chips obtained by using the preparation method according to claim 1.

7. The waste oriented wood chips according to claim 6, wherein the softening comprises impregnating the waste oriented strand board in water.

8. The waste oriented wood chips according to claim 7, wherein the impregnating is normal pressure impregnation or vacuum pressure impregnation.

9. The waste oriented wood chips according to claim 6, wherein upon flaking, the disc flaker is operated at a revolving speed of 15 to 35 rpm with a knife sharpness angle of 17° to 32°, a back micro-bevel angle of 5° to 35°, a counter knife angle of 38° to 78°, a knife clearance angle of 1° to 10°, and a knife projection of 0.2 to 1.0 mm.

10. The waste oriented wood chips according to claim 6, further comprising drying the wood chips to obtain the waste oriented wood chips after the flaking, wherein the waste oriented wood chips each have a moisture content of 2-14wt %.

11. An oriented strand board, comprising a top surface layer, a bottom surface layer, and a core layer disposed between the top surface layer and the bottom surface layer,
wherein raw materials for the top surface layer and the bottom surface layer comprise fresh wood chips, wax and an isocyanate resin;
raw materials for the core layer comprise waste oriented wood chips, fresh wood chips, wax and an isocyanate resin; the waste oriented wood chips are the waste oriented wood chips obtained by using the preparation method according to claim 1; and the waste oriented wood chips accounts for no more than 75% by mass of the core layer.

12. The oriented strand board according to claim 11, wherein the softening comprises impregnating the waste oriented strand board in water.

13. The waste oriented wood chips according to claim 12, wherein the impregnating is normal pressure impregnation or vacuum pressure impregnation.

14. The waste oriented wood chips according to claim 11, wherein upon flaking, the disc flaker is operated at a revolving speed of 15 to 35 rpm with a knife sharpness angle of 17° to 32°, a back micro-bevel angle of 5° to 35°, a counter knife angle of 38° to 78°, a knife clearance angle of 1° to 10°, and a knife projection of 0.2 to 1.0 mm.

15. The waste oriented wood chips according to claim 11, further comprising drying the wood chips to obtain the waste oriented wood chips after the flaking, wherein the waste oriented wood chips each have a moisture content of 2-14wt %.

16. The oriented strand board according to claim 11, wherein the raw materials for the top surface layer and the bottom surface layer further comprise waste oriented wood chips.

17. The oriented strand board according to claim 11, wherein an included angle between laid wood chips of the top surface layer, the core layer and the bottom surface layer is 0° to 90°.

18. The oriented strand board according to claim 17, wherein an included angle between laid wood chips of the top surface layer, the core layer and the bottom surface layer is 0° to 90°.

19. A preparation method of the oriented strand board according to claim 11, comprising the following steps:
mixing the raw materials for the top surface layer, the raw materials for the bottom surface layer and the raw materials for the core layer to obtain a top surface layer mixture, a bottom surface layer mixture, and a core layer mixture, respectively;
laying the top surface layer mixture, the bottom surface layer mixture, and the core layer mixture orderly from bottom to top to obtain a mat; and
subjecting the mat to hot pressing to obtain the oriented strand board.

20. A preparation method of the oriented strand board according to claim 16, comprising the following steps:
mixing the raw materials for the top surface layer, the raw materials for the bottom surface layer and the raw materials for the core layer to obtain a top surface layer mixture, a bottom surface layer mixture, and a core layer mixture, respectively;
laying the top surface layer mixture, the bottom surface layer mixture, and the core layer mixture orderly from bottom to top to obtain a mat; and
subjecting the mat to hot pressing to obtain the oriented strand board.
